(19) United States
(12) Patent Application Publication
(10) Pub. No.: US 2004/0044426 A1
(43) Pub. Date: Mar. 4, 2004

(54) Program for causing a computer to execute a method of generating mesh data and apparatus for generating mesh data

(75) Inventors: Akira Ueda, Kawasaki (JP); Koichi Shimizu, Kawasaki (JP); Kenichiro Aoki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/647,250

(22) Filed: Aug. 26, 2003

(30) Foreign Application Priority Data
Aug. 30, 2002 (JP) 2002-255924

(51) Int. Cl. G06F 17/00

(52) U.S. Cl. 700/90

(57) ABSTRACT

A method of generating mesh data includes the steps of: (a) forming grid lines orthogonally crossing each other over a target object; (b) forming cube data from mesh data obtained by dividing the target object by the grid lines, the cube data being formed of cube elements that are mesh elements forming the target object; and (c) reducing the cube elements in number by combining the cube elements in accordance with a predetermined condition.

### BACKGROUND OF THE INVENTION

1. Field of the Invention

The present invention generally relates to programs for causing a computer to execute a method of generating mesh data and apparatuses for generating mesh data, and more particularly to a program for causing a computer to execute a mesh data generating method capable of relatively simply generating highly accurate mesh data and a mesh data generating apparatus suitable for such a method.

2. Description of the Related Art

Herein, mesh data refers to data that is obtained by dividing a predetermined structure into a mesh of elements, providing each mesh element or cube element with a characteristic value representing the characteristics of the mesh or cube element, and approximating the structure by the set of the mesh or cube elements in the case of performing analyses using a computer, such as a structural analysis, a heat transfer analysis, a fluid analysis, a thermal fluid analysis, and an electromagnetic field analysis, so that such analyses are effectively performed.

In recent years, as electronic devices have been reduced in size and weight as peripheral devices for computers, it has been required to design the structure of the electronic devices, especially, printers, so that the behavior of heat generated therefrom is suitably controlled. For this purpose, it is necessary to analyze the behavior of heat in the complicated internal structures of the electronic devices with good accuracy. Thermal fluid analysis is a technology for achieving such accurate analysis, and mesh data is employable as data to be provided to a tool for performing the analysis by a computer, that is, software.

Basically, the mesh data is “even mesh data” that is formed of equally shaped mesh or cube elements. Meanwhile, a method that generates so-called “uneven mesh data” by intentionally varying the mutual shapes of the mesh or cube elements for various reasons is proposed.

Japanese Laid-Open Patent Application No. 10-289332 (first prior art), for instance, discloses a mesh re-dividing method that performs mesh re-division in accordance with a predetermined condition so that a region requiring high simulation calculation accuracy can be divided more finely.

Japanese Laid-Open Patent Application No. 4-000679 (second prior art) discloses a coordinate grid creation supporting method for creating a desired coordinate grid including a plurality of coordinate grids with different grid densities in order to obtain mesh data used for fluid analysis.

Further, Japanese Laid-Open Patent Application No. 6-274573 (third prior art) discloses a system for creating a mesh for numerical analysis which system, in changing the state of density of mesh data for adjusting the accuracy of numerical analysis, performs the adjustment operation efficiently by applying a smoothing technology.

### SUMMARY OF THE INVENTION

According to the first prior art, however, the number of grid lines dividing the mesh data is increased by the re-division. In the case of using the thus obtained mesh data as data input to an analysis tool whose amount of processing in analysis operation depends on the number of grid lines, the amount of processing in analysis operation increases.

The second prior art provides no expatiation of how to actually obtain mesh data from the surface shape of an object of analysis.

Further, the third prior art provides no specific description of a method for reducing the number of mesh elements.

Accordingly, it is a general object of the present invention to provide a method of generating mesh data in which the above-described disadvantages are eliminated.

A more specific object of the present invention is to provide a method of generating mesh data which method can reduce the amount of data of the mesh data with a relatively simple configuration.

The above objects of the present invention are achieved by a method of generating mesh data including the steps of: (a) forming grid lines orthogonally crossing each other over a target object; (b) forming cube data from mesh data obtained by dividing the target object by the grid lines, the cube data being formed of cube elements that are mesh elements forming the target object; and (c) reducing the cube elements in number by combining the cube elements in accordance with a predetermined condition.

The above objects of the present invention are also achieved by a program for causing a computer to execute a method of generating mesh data, the method including the steps of: (a) forming grid lines orthogonally crossing each other over a target object; (b) forming cube data from mesh data obtained by dividing the target object by the grid lines, the cube data being formed of cube elements that are mesh elements forming the target object; and (c) reducing the cube elements in number by combining the cube elements in accordance with a predetermined condition.

The above objects of the present invention are also achieved by a computer-readable recording medium storing a program for causing a computer to execute a method of generating mesh data, the method including the steps of: (a) forming grid lines orthogonally crossing each other over a target object; (b) forming cube data from mesh data obtained by dividing the target object by the grid lines, the cube data being formed of cube elements that are mesh elements forming the target object; and (c) reducing the cube elements in number by combining the cube elements in accordance with a predetermined condition.

The above objects of the present invention are further achieved by an apparatus for generating mesh data including: a setting part forming grid lines orthogonally crossing each other over a target object; a calculation part obtaining cube data from mesh data obtained by dividing the target object by the grid lines, the cube data being formed of cube elements that are mesh elements forming the target object; and a combining part combining the cube elements of the cube data in accordance with a predetermined condition.

According to the present invention, the amount of data can be effectively reduced in generating mesh data to be applied to the thermal fluid analysis tool of an electronic device. As a result, in the case of causing a computer to execute the method of the present invention, the amount of processing and time required in analysis operation can be effectively reduced, so that the thermal fluid analysis of the electronic device can be performed far more efficiently.

### BRIEF DESCRIPTION OF THE DRAWINGS

Other objects, features and advantages of the present invention will become more apparent from the following detailed description when read in conjunction with the accompanying drawings, in which:

FIG. 1 is a diagram for illustrating an operation of a thermal fluid analysis tool to which the present invention is applicable according to an embodiment of the present invention;

FIGS. 2A through 2E are diagrams for illustrating the operation of the thermal fluid analysis tool to which the present invention is applicable according to the embodiment of the present invention;

FIGS. 3A through 3D are diagrams for illustrating the operation of the thermal fluid analysis tool to which the present invention is applicable according to the embodiment of the present invention;

FIGS. 4A and 4B are diagrams showing a case of converting polygon data such as CAD data to cube data for thermal fluid analysis according to the embodiment of the present invention;

FIGS. 5A and 5B are diagrams for illustrating a common method of generating mesh data;

FIGS. 6A through 6C are diagrams for illustrating a method of generating mesh data according the embodiment of the present invention;

FIG. 7 is a flowchart for illustrating the method of generating mesh data according to the embodiment of the present invention;

FIGS. 8A and 8B are diagrams for illustrating the method of generating mesh data according to the embodiment of the present invention;

FIGS. 9A through 9C are diagrams for illustrating the method of generating mesh data according to the embodiment of the present invention;

FIGS. 10A and 10B are diagrams for illustrating the method of generating mesh data according to the embodiment of the present invention; and

FIG. 11 is a block diagram showing a computer to which the present invention is applicable according to the embodiment of the present invention.

### DETAILED DESCRIPTION OF THE PREFERRED EMBODIMENTS

A description will now be given, with reference to the accompanying drawings, of an embodiment of the present invention.

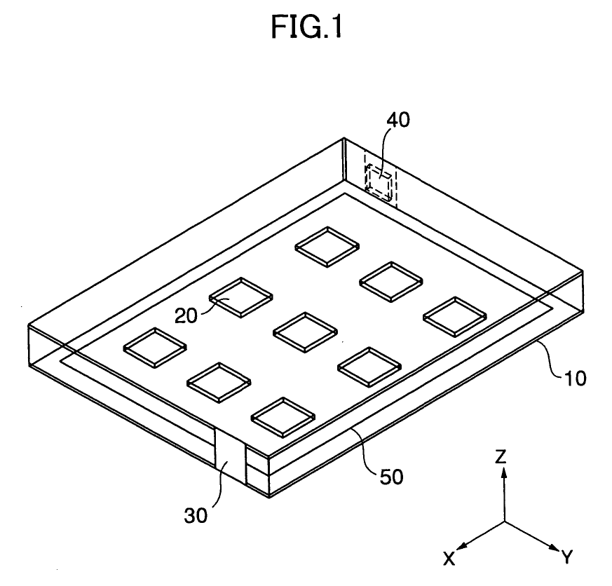

First, a description will be given, with reference to FIGS. 1 through 3, of an operation of a software program as a thermal fluid analysis tool to which the present invention is applicable.

FIG. 1 is a perspective view of an electronic device that is an object of analysis to be subjected to thermal fluid analysis by the analysis tool. As shown in FIG. 1, the electronic device includes multiple printed circuit boards (PCB) 20 as heat generating sources provided on a PCB table 50 in a housing 10. The housing 10 includes an intake fan 40 and an outlet 30 for discharging heat generated from the PCBs 20.

An operator inputs the structure information of an object of analysis (an object to be analyzed) as shown in FIG. 1 to the analysis tool by performing a predetermined input operation on a computer terminal installed with software forming the analysis tool. In this case, the analysis tool has special applications dedicated to the respective components of the object of analysis including its housing, so that input items including the basic characteristics of each component, such as size data, are prepared. That is, data on the housing 10 and data on openings such as an inlet to which the intake fan 40 is provided and the outlet 30 are input by using an application for housing input and an application for opening input, respectively. Data on the intake fan 40 is input by selecting the corresponding item from a prepared library. Likewise, a special tool is prepared for inputting data on the PCBs 20.

After thus inputting the structural data of the object of analysis, for thermal fluid analysis, environmental temperature and pressure data are input and a convective heat transfer coefficient determining the amount of heat dissipation from the surface of the housing 10 is set.

The operation of inputting the data on the housing 10 will be expatiated below. Specifically, the size, plate thickness, and material of the housing 10 are input. Further, the surfaces on which the inlet and the outlet 30 are formed are selected, and the coordinate positions of the inlet and the outlet 30 are input. When the material data is input, the analysis tool automatically sets the corresponding heat conductivity and plate surface heat emissivity. Further, the intake fan 40 is selected from the library so that the analysis tool automatically sets the corresponding predetermined fan characteristics. Further, with respect to the intake fan 40, data on the depth of its position in the direction of the thickness of the housing 10 is also set. Furthermore, air-flow resistance should be set for the outlet 30. Specifically, the analysis tool automatically calculates and sets the air-flow resistance by setting the opening of the outlet 30. At this point, the operation efficiency can be increased by selecting the opening from the prepared library.

With respect to each of the PCBs 20, the size, the materials of its insulators and conductors, the thickness of each of its wiring layers, and the wiring rate are set. Further, the amount of heat generated from, the number of, and the radiation characteristics of electronic components mounted on each of the PCBs 20 are set. At this point, however, it is not necessary to know the behavior of the temperature of each individual component on each PCB 20. It is considered that the entire surface of each PCB 20 evenly generates heat, and the heat-generating position and the amount of heat generated of each electronic component included in each PCB 20 are individually ignored.

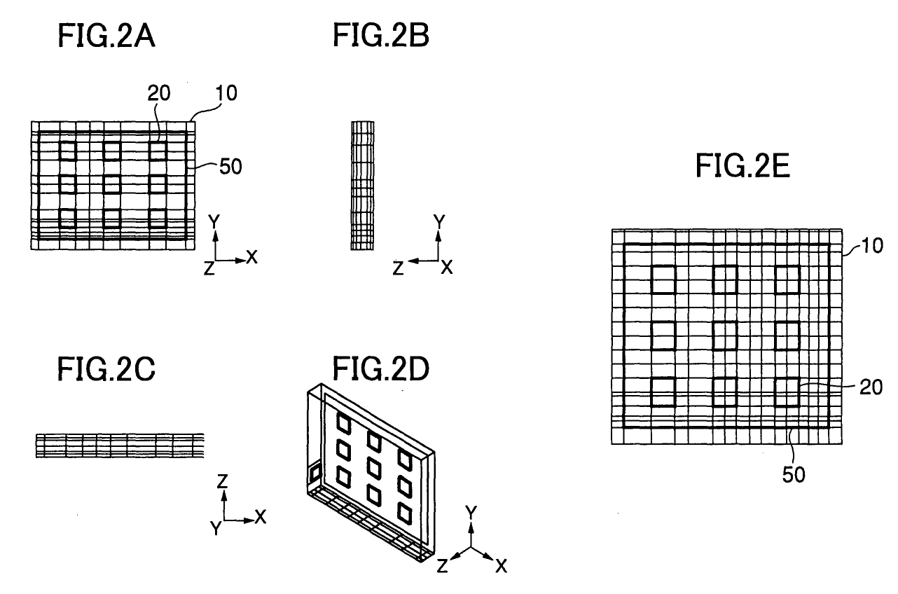

Further, gridding is performed. Gridding is an operation of dividing the internal and external predetermined spaces of the object of analysis into a mesh of elements based on the disposition and the data on the outside dimensions of each component input as shown in FIG. 1. A grid is automatically formed on the ridge lines of all of the components attached and set as shown in FIG. 1. Generally, analysis cannot be performed with sufficient accuracy with this grid only, so that an additional grid is formed. FIGS. 2A through 2C are diagrams showing the state before the grid-adding operation. FIG. 2D is a perspective view corresponding to FIG. 1. FIG. 2E is a diagram showing the state where the additional grid is formed. By thus forming the additional grid, the entire object of analysis is covered evenly with the grids. Thereafter, actual calculation methods for thermal fluid analysis (pressure and temperature equations) are selected, and other detailed calculation conditions are set.

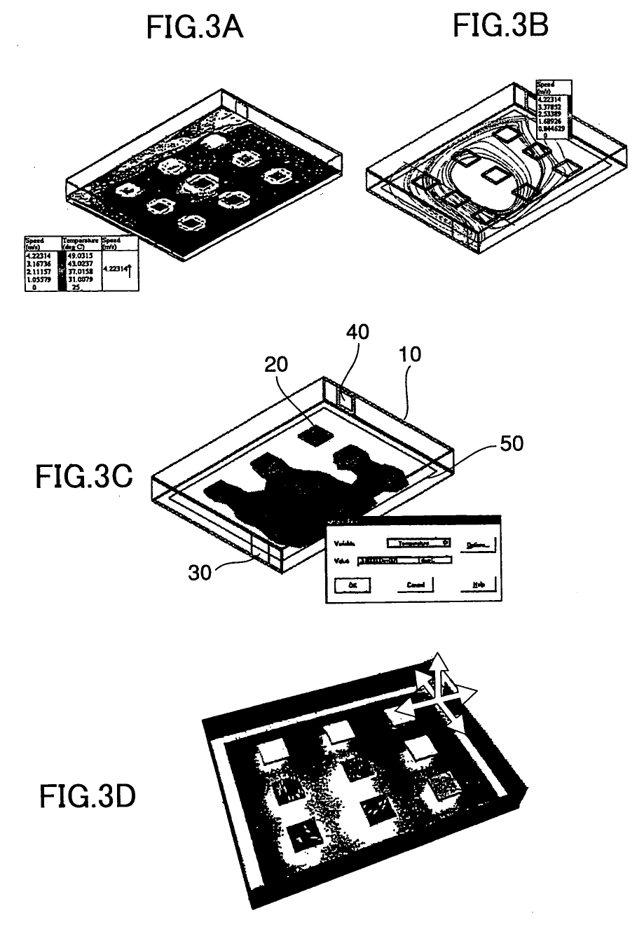

FIGS. 3A through 3D are diagrams showing the results of a thermal fluid analysis simulation performed on the electronic device by a computer using the analysis tool based on the setting after the above-described setting operation. FIG. 3A shows a temperature distribution on the PCB table 50 in the electronic device as the object of analysis. FIG. 3B shows a thermal fluid flow pattern in the electronic device. FIG. 3C shows an equal temperature surface in the electronic device. FIG. 3D shows the surface temperature of each component in the electronic device.

Based on the thus obtained simulation results of the temperature distribution of the components, the disposition of the PCBs 20, the capacity of the intake fan 40, the size of the inlet and the outlet 30, the size and the material of each component, and the heat resistance capacity of each mounted component of each PCB 20 are re-examined. By repeating these operations, an optimum structure for the electronic device can be designed with efficiency in consideration of the behavior of thermal fluid inside the electronic device.

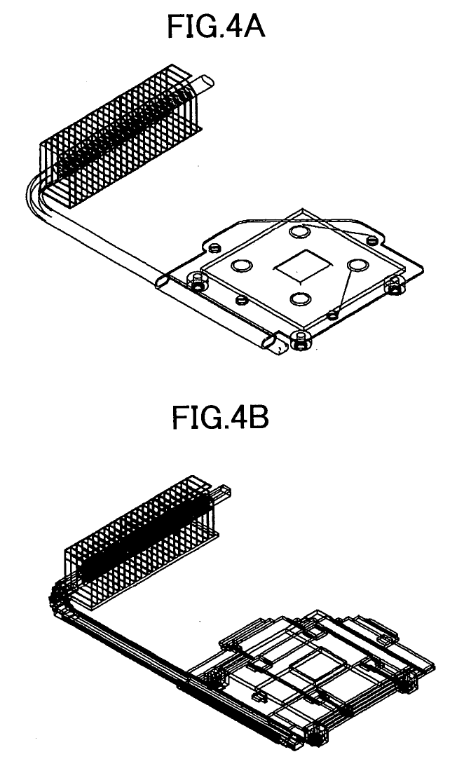

In inputting the position and the size data of each component as shown in FIG. 1, it is not necessarily required that the operator input the size and the coordinate position of each component one by one as previously described. Alternatively, it is possible to use the CAD data (IGES or STEP) obtained at the time of designing the electronic device by temporarily converting the CAD data into polygon data such as STL data. Specifically, as shown in FIGS. 4A and 4B, the polygon data of FIG. 4A is converted into the cube data (corresponding to an orthogonal mesh) for thermal fluid analysis of FIG. 4B, so that the structural input data suitable for the thermal fluid analysis tool as shown in FIG. 1 can be obtained. By setting the characteristic values (material and amount of heat generated) of each component for the structural data, the above-described set inputs for thermal fluid analysis can be obtained.

Thus, instead of the CAD data, the polygon data to which the CAD data is converted is used as data to be supplied to the thermal fluid analysis tool. The polygon data has a data structure formed of vertex information. Therefore, a vertex search can be performed at high speed at the time of performing analysis by the thermal fluid analysis tool. Further, the polygon data has a simple data structure so that the processing algorithm of the thermal fluid analysis tool is simplified. As a result, by obtaining the cube data from the polygon data, the mesh generating operation can be performed efficiently on a complicated model shape.

The present invention is applicable not only to this thermal fluid analysis tool, but also to other analysis tools such as a structural analysis tool and an electromagnetic field analysis tool. In the case of the structural analysis tool, the present invention is applicable in generating well-known FEM data (including nodes and element data). In the case of the electromagnetic field analysis tool, the present invention is applicable in generating well-known surface data.

Next, a description will be given of a conventional method of generating mesh data for these various analysis tools, for instance, cube data conforming to an orthogonal mesh for a thermal fluid analysis tool. This method is applicable as the method of obtaining cube data from original CAD data described above with reference to FIGS. 4A and 4B.

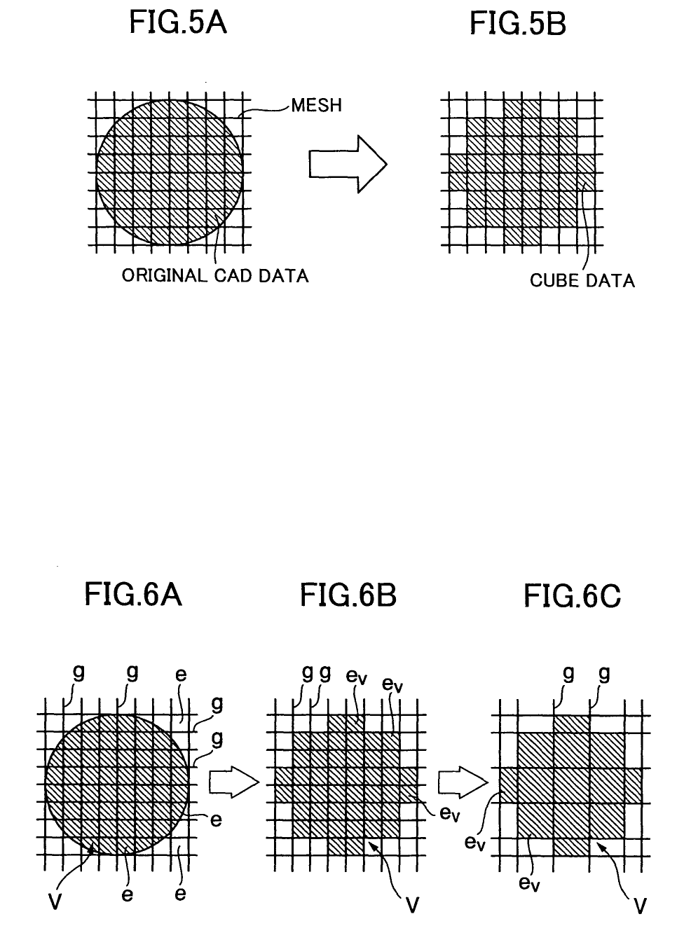

FIGS. 5A and 5B show a method of converting spherical data as original CAD data into cube data. In this case, as shown in FIG. 5A, a mesh is formed with grid lines on a target object (an object of analysis) represented by the original CAD data. Then, the cubes as mesh elements are divided into those forming the elements of the target object and those not forming the elements of the target object based on a criterion such as whether the ratio of the volume that the original CAD data of the target object occupies in the cube forming a mesh element to the volume of the cube (mesh element) is larger than or equal to a constant value. The mesh elements that are determined to be the elements of the target object are referred to as cube elements. As a result, the cube data formed of the cube elements and conforming to an orthogonal mesh as shown in FIG. 5B can be obtained. The cube elements are formed of cubes or rectangular parallelepipeds of the same size.

According to such a mesh data generating method, the number of the cube elements forming the target object is equal to the number of the mesh elements formed by the initially formed grid lines. Therefore, when the number of grid lines is increased while preserving the shape of the target object as much as possible in obtaining mesh data, the resulting number of cube elements increases. As a result, the amount of processing required in analysis operation to which the cube data or mesh data thus obtained is applied increases accordingly.

Next, a schematic description will be given, with reference to FIGS. 6A through 6C, of a method of generating mesh data according to the embodiment of the present invention. First, as shown in FIG. 6A, grid lines q are formed at predetermined equal intervals like a mesh over a sphere V as a target object. Then, with respect to each of the cubic mesh elements e formed by the grid lines q, it is determined whether the cubic mesh element forms the target object V based on a predetermined criterion as previously described. Thereby, cube data or mesh data as shown in FIG. 6B is obtained. In FIG. 6B, the filled-in part corresponds to mesh elements eᵥ that are determined to form the target object V, that is, the cube elements. Although FIGS. 6A through 6C provides a two-dimensional graphical representation for convenience of description, the target object V is actually a three-dimensional solid. The above-described determination operation is equally performed on the X-Y, X-Z, and Y-Z planes, so that it is determined whether each of the mesh elements e forms the target object V.

Thereafter, as shown in FIG. 6C, the mesh elements eᵥ determined to form the target object V, that is, the cube elements, are combined (merged) in accordance with a predetermined condition. At the same time, the grid lines g that partition the combined cube elements are deleted as shown in FIG. 6C. As shown in FIG. 6C, both the number of cube elements eᵥ and the number of grid lines g are significantly reduced compared with the state of FIG. 6B. In this case, the shape of all the cube elements eᵥ forming the target object V, that is, the shape of the filled-in part remains the same before and after the combining operation, as can be seen by comparing FIGS. 6B and 6C, namely, the states before and after the combining operation. That is, the shape of the target object V is completely preserved even after the combining operation. Accordingly, as far as the shape of the target object V is concerned, no degradation of the accuracy of analysis occurs in the subsequent analysis to which the thus obtained mesh data is applied. Therefore, the amount of processing in analysis operation can be effectively reduced. As will be described later, the cube element combining operation according to the embodiment of the present invention does not necessarily consider that it is essential for the cube elements forming the target object to completely preserve the shape and/or the total volume of the target object V. The combining operation sets variations based on various conditions.

In this case, the shape or the contour of the target object V is preserved after the combining operation as previously described with the result that the volume of the target object V is also preserved. Further, as in the previous description, the two-dimensional graphical representation is also employed in the description of the combining operation for convenience of description. Actually, however, the combining operation is intended for a three-dimensional solid. The combination operation is temporarily performed equally on the X-Y, X-Z, and Y-Z planes, and the combination operation is finally performed only on a combination of combinable or mergeable cube elements which combination is formed in each of the three planes.

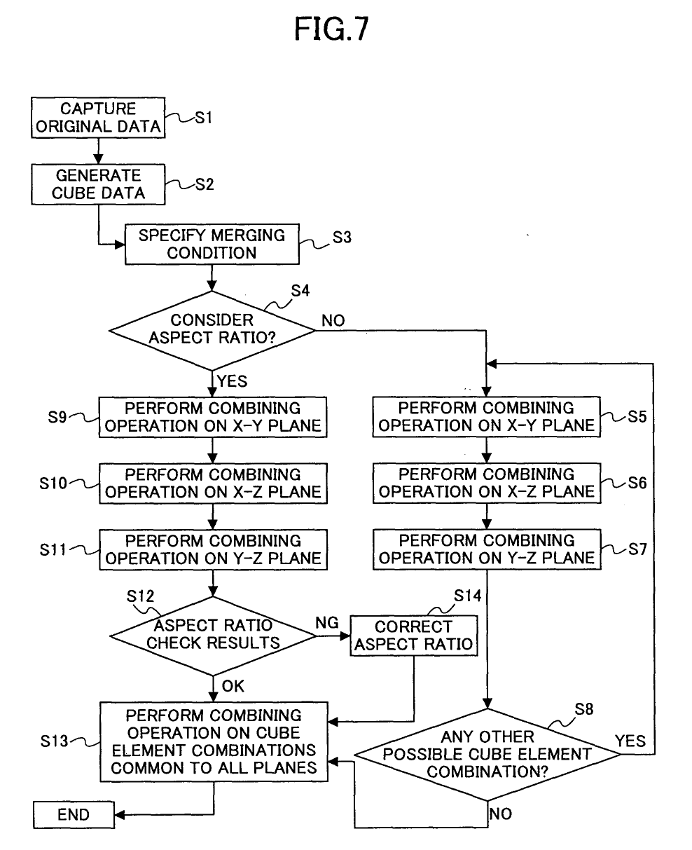

Next, an expatiation will be given, with reference to FIGS. 7 through 10B, of the embodiment of the present invention. FIG. 7 is a flowchart for illustrating the method of generating mesh data according to the embodiment of the present invention.

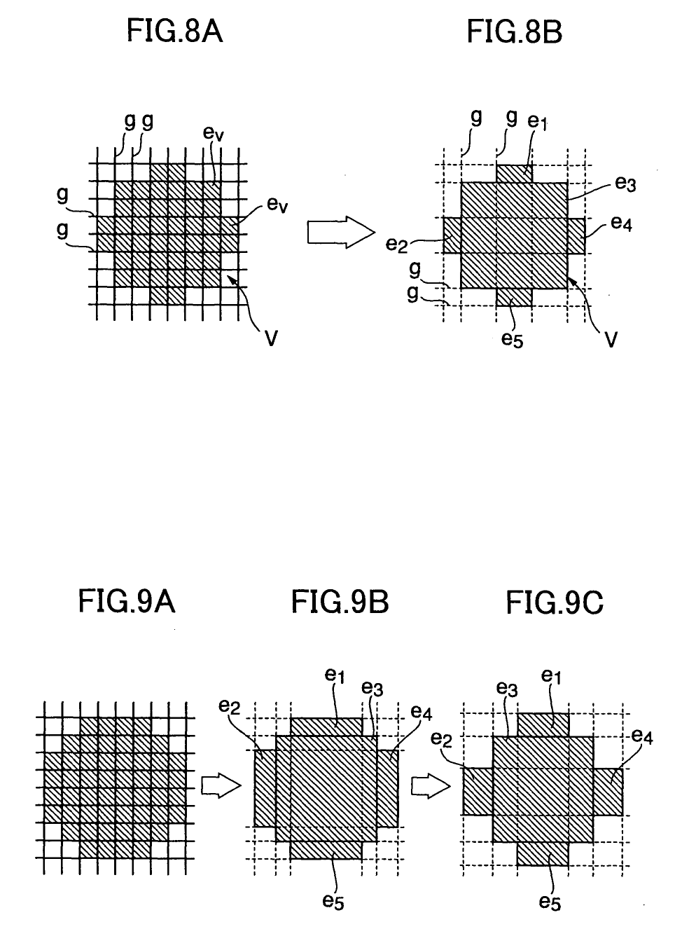

In step S1 of FIG. 7, the original CAD data of the target object V is captured. Next, in step S2, as previously described with reference to FIGS. 6A through 6C, the grid lines g are formed at predetermined equal intervals over the target object V represented by the captured original CAD data, and with respect to each of the mesh elements e partitioned by the grid lines g, it is determined whether the mesh element forms the target object V based on an index, such as the ratio of volume of the target object V in the mesh element to the volume of the mesh element. Thereby, mesh data (cube data) as shown in FIG. 8A or 9A is obtained.

Next, in step S3, the operator specifies a condition for the combining (merging) of cube elements by inputting a setting. As a result, in step S4, it is determined whether to consider the aspect ratio of a composite cube element formed after the combining of cube elements. If it is determined in step S4 that the aspect ratio of a composite cube element is not to be considered, in steps S5, S6, and S7, the cube element combining operation is temporarily performed on the X-Y, X-Z, and Y-Z planes of the mesh data, respectively. Specifically, as shown in FIGS. 8A and 8B, adjacent cube elements are combined, for instance. Then, in step S8, it is determined whether there is any other possible combination of combinable cube elements. If it is determined in step S8 that there is another possible combination of combinable cube elements, the process returns to steps S5, S6, and S7, so that the temporary combining operation is again performed. The same operation is repeated until the determination result of step S8 becomes “NO.”

When the determination result of step S8 becomes “NO,” in step S13, the actual or final combining operation is performed only on a combination of combinable cube elements which combination is common to all the three planes as a result of steps S5 through S7.

Meanwhile, if it is determined in step S4 that the aspect ratio of a composite cube element is to be considered, in steps S9, S10, and S11, the combining operation is temporarily performed on the X-Y, X-Z, and Y-Z planes of the mesh data as in steps S5, S6, and S7, respectively. Then, in step S12, the aspect ratio of each composite cube element obtained as a result of the temporary combining operation in each of steps S9 through S11 is checked with an allowable aspect ratio. Specifically, in the case of FIG. 8B, for instance, the aspect ratios of composite cube elements e₁ through e₅ are 1:2, 2:1, 6:6, 2:1, and 1:2, respectively. The aspect ratio of a composite cube element is the ratio of length to width, that is, the ratio of one to the other of the lengths of adjacent sides of the rectangular surface of the composite cube element. In this case, the largest aspect ratio is two. On the other hand, in the case of FIG. 9B, the aspect ratios of the composite cube elements e₁ through e₅ are 1:4, 4:1, 6:6, 4:1, and 1:4, respectively. In this case, the largest aspect ratio is four. If the allowable aspect ratio is set to two, the aspect ratio check result of step S12 is “OK” in the case of FIG. 8B and is “NG (no good)” in the case of FIG. 9B. In each of the cases of FIGS. 8B and 9B, both the shape and the total volume of all of the mesh elements forming the target object V, that is, the cube elements eᵥ are completely preserved through the cube element combining operation.

If the result of step S12 is “OK,” in step S13, as previously described, the combining operation is finally performed only on a combination of combinable cube elements which combination is common to or formed in all of the three planes as a result of steps S9 through S11. On the other hand, if the result of step S12 is “NG,” that is, in the case of FIG. 9B, in step S14, on condition that the total volume of the mesh elements forming the target object V, that is, the cube elements eᵥ or the composite cube elements e₁ through e₅ is preserved, namely, without changing the volume of each cube element eᵥ, the shape of each of the composite cube element e₁, e₂, e₄, and e₅ each having an aspect ratio exceeding the above-described set condition is varied. That is, as shown in FIG. 9C, for instance, the cube elements eᵥ are differently combined so that the longitudinal dimension is increased and the horizontal dimension is reduced with respect to the composite cube elements e₁ and e₅ and the longitudinal dimension is reduced and the horizontal dimension is increased with respect to the composite cube elements e₂ and e₄. Thereby, the aspect ratios of these composite cube elements are improved. In the case of FIG. 9C, the cube data obtained as a result of the combining operation is formed by the combinations of cube elements in the same state as that of FIG. 8B. Actually, the aspect ratio improvement operation of step S14 is performed in consideration of the three-dimensional shape of the target object V so that in each of the X-Y, Y-Z, and X-Z planes, the corresponding aspect ratio of each composite cube element is improved.

In step S13, with the combinations of combinable cube elements being adjusted so that the aspect ratios of the composite cube elements are improved, the combining operation is finally performed only on a combination of combinable cube elements which combination is common to all of the X-Y, Y-Z, and X-Z planes as a result of the adjustment of the combinations of the cube elements of the composite cube elements with respect to the three planes.

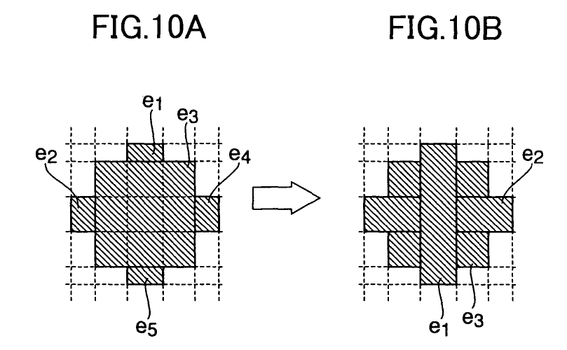

FIGS. 10A and 10B are diagrams for illustrating an operation performed when it is determined in step S4 that the aspect ratio is not to be considered, that is, in the case of “NO” in step S4. In this case, for instance, the cube data of FIG. 8B is obtained as a result of the first combining operation through steps S5 through S7, and in this state, namely, in the state of FIG. 10A, it is determined in step S8 that there is another possible combination of combinable cube elements (that is, “YES” in step S8). In this case, as shown in FIG. 10B, the composite cube elements e₁ and e₅ and part of the composite cube element e₃ are combined into a new composite cube element e₁, and likewise, the composite cube elements e₂ and e₄ and part of the composite cube element e₃ are combined into a new composite cube element e₂.

As in all of the previous cases, it is also required in the case of FIGS. 10A and 10B that the new composite cube elements e₁, e₂, and e₃ formed by the second combining operation be rectangular parallelepipeds. Therefore, strictly speaking, the original shape of the target object V, although preserved in the plane shown in the drawings, is not preserved in the other planes orthogonal thereto. However, if the target object V has smaller dimensions in the planes orthogonal to the plane shown in the drawings, that is, if the target object V does not have much thickness, the cube element combining operation substantially preserves the shape of the target object V in each of the X-Y, Y-Z, and X-Z planes.

By thus reducing the number of cube elements of a target object by suitably combining the cube elements, the amount of processing can be effectively reduced in the operation of a thermal fluid analysis simulation as previously described with reference to FIGS. 1 through 3D to which simulation the mesh data of the target object is applied. Particularly, in the case of not considering any aspect ratio, that is, in the case of “NO” in step S4, the amount of processing can be further reduced by repeating the combining of cube elements as many times as possible while satisfying the condition that the resulting composite cube elements are rectangular parallelepipeds.

On the other hand, the aspect ratio of a composite cube element may be limited by an analysis operation method depending on an analysis tool to which the mesh data obtained by the mesh data generating method is applied. In such a case, it should be determined in step S4 that the aspect ratio is to be considered, so that the aspect ratio is confined within the limits.

In the combining operation of each of the cases of FIGS. 8B and 9B, the number of grid lines g is reduced, so that the total number of mesh elements is also reduced. Therefore, it is ensured that the amount of processing in the subsequent analysis operation to which the mesh data of FIG. 8B or 9B is applied is reducible. Here, the total number of mesh elements refers to the number of mesh elements of the entire mesh data. The mesh elements of all the mesh data include those forming the target object V and those not forming the target object V, that is, those forming the external space of the target object V.

On the other hand, in the case of FIGS. 10A and 10B, the number of grid lines g remains the same, so that the total number of mesh elements also remains the same. Even in such a case, however, the number of cube elements of the target object V is reduced from five to three. Normally, in the operation of analysis such as thermal fluid analysis, the target object V is considered as formed of as many elements as the number of cube elements of the target object V, so that as many characteristic values as the number of cube elements are set. Accordingly, by reducing the number of cube elements, it is also possible to effectively reduce the amount of processing in the analysis operation.

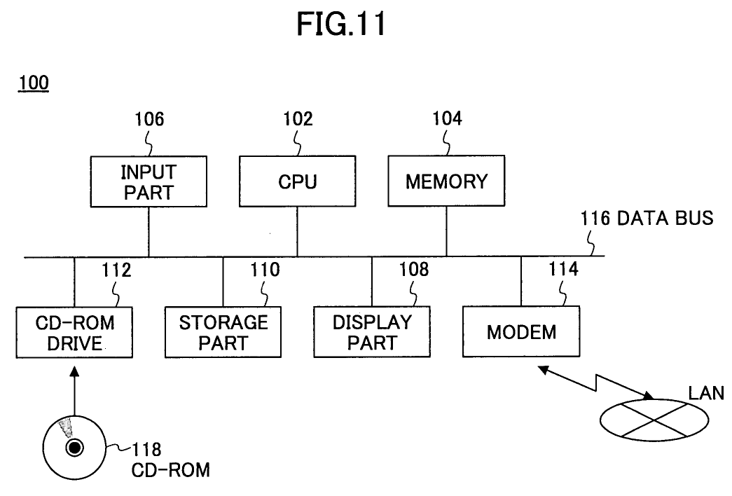

FIG. 11 is a block diagram showing a computer 100 to which the present invention is applicable. The computer 100 includes a CPU 102, a memory 104, an input part 106 for an operator inputting required data, a display part 108 displaying the results of the operations of the CPU 102 to the operator, a storage part 110 storing a variety of programs, a CD-ROM drive 112, and a modem 114 controlling communication with a communication network such as a LAN. The CPU 102, together with the memory 104, performs a variety of operations. The above-described components of the computer 100 are connected via a data bus 116.

A software program for causing the computer 100 to perform the method of generating mesh data described with reference to FIGS. 7 through 10B is recorded in a CD-ROM 118, for instance, and is read out therefrom by the CD-ROM drive 112 to be temporarily stored in the storage part 110. The CPU reads out the software program from the storage part 110, and executes the above-described method of generating mesh data in accordance with the software program, suitably using the memory 104. The software program may be downloaded via the LAN from another server instead of being read out from the CD-ROM 118.

The software program according to the present invention is thus executed by the computer 100, so that the computer 100 can be realized as an apparatus including a part having characteristics according to the present invention.

Practically, it is preferable that the software program be used in combination with the software program forming the thermal fluid analysis tool described with reference to FIGS. 1 through 3D. That is, the original CAD data is converted to mesh data as shown in FIGS. 6A through 6C by the software program for generating mesh data according to the embodiment, and the thus obtained mesh data is employed as data to be input to the thermal fluid analysis tool. As a result, inputting the size and the coordinate position of each of the components forming the electronic device as the object of analysis can be omitted. Adding grid lines can also be omitted. Therefore, a simulation of analysis can be performed by the operator inputting only the characteristic data such as material and the amount of heat generated of each component and setting the analysis conditions.

Thus, according to the present invention, the amount of data can be effectively reduced in generating mesh data to be applied to the thermal fluid analysis tool of an electronic device. As a result, in the case of causing a computer to execute the method of the present invention, the amount of processing and time required in analysis operation can be effectively reduced, so that the thermal fluid analysis of the electronic device can be performed far more efficiently.

The present invention is not limited to the specifically disclosed embodiment, but variations and modifications may be made without departing from the scope of the present invention.

The present application is based on Japanese priority application No. 2002-255924 filed on Aug. 30, 2002, the entire contents of which are hereby incorporated by reference.

What is claimed is:

1. A method of generating mesh data comprising the steps of:
(a) forming grid lines orthogonally crossing each other over a target object;
(b) forming cube data from mesh data obtained by dividing the target object by the grid lines, the cube data being formed of cube elements that are mesh elements forming the target object; and
(c) reducing the cube elements in number by combining the cube elements in accordance with a predetermined condition.

2. The method as claimed in claim 1, wherein the cube data is obtained by determining whether each of mesh elements forming the mesh data forms the target object based on a condition of the target object in the mesh element.

3. The method as claimed in claim 2, wherein the condition of the target object in the mesh element is a ratio of volume of the target object in the mesh element to volume of the mesh element.

4. The method as claimed in claim 1, wherein said step (c) is performed only when the combining of the cube elements is prevented from changing a shape of the target object formed of the cube data.

5. The method as claimed in claim 1, wherein said step (c) is performed so that a substantial shape of the target object formed of the cube data is preserved after the combining of the cube elements.

6. The method as claimed in claim 1, wherein said step (c) is performed only when the combining of the cube elements is prevented from substantially changing a total volume of the cube elements.

7. The method as claimed in claim 1, wherein said step (c) is performed so that a substantial total volume of the cube elements is preserved after the combining of the cube elements.

8. The method as claimed in claim 1, wherein said step (c) combines the cube elements into composite cube elements so that an aspect ratio of each of surfaces of each of the composite cube elements falls within a predetermined range.

9. The method as claimed in claim 8, wherein:
each of the composite cube elements has a rectangular parallelepiped shape; and
the aspect ratio of each of the surfaces of each of the composite cube elements is a ratio of a length of a first side to a length of a second side of the surface, the first and second sides being orthogonal to each other.

10. The method as claimed in claim 1, wherein the grid lines partitioning the cube elements are reduced in number as the cube elements are combined to be reduced in number.

11. A program for causing a computer to execute a method of generating mesh data, the method comprising the steps of:
(a) forming grid lines orthogonally crossing each other over a target object;
(b) forming cube data from mesh data obtained by dividing the target object by the grid lines, the cube data being formed of cube elements that are mesh elements forming the target object; and
(c) reducing the cube elements in number by combining the cube elements in accordance with a predetermined condition.

12. A computer-readable recording medium storing a program for causing a computer to execute a method of generating mesh data, the method comprising the steps of:
(a) forming grid lines orthogonally crossing each other over a target object;
(b) forming cube data from mesh data obtained by dividing the target object by the grid lines, the cube data being formed of cube elements that are mesh elements forming the target object; and
(c) reducing the cube elements in number by combining the cube elements in accordance with a predetermined condition.

13. An apparatus for generating mesh data comprising:
a setting part forming grid lines orthogonally crossing each other over a target object;
a calculation part obtaining cube data from mesh data obtained by dividing the target object by the grid lines, the cube data being formed of cube elements that are mesh elements forming the target object; and
a combining part combining the cube elements of the cube data in accordance with a predetermined condition.
